(19) United States
(12) Patent Application Publication
(10) Pub. No.: US 2023/0080509 A1
(43) Pub. Date: Mar. 16, 2023

(54) PROCESSING DEVICE AND IMAGE FORMING SYSTEM

(71) Applicant: Konica Minolta Inc., Tokyo (JP)

(72) Inventor: Masaaki UCHIYAMA, Sagamihara-shi (JP)

(21) Appl. No.: 17/943,498

(22) Filed: Sep. 13, 2022

(30) Foreign Application Priority Data
Sep. 16, 2021 (JP) 2021-151201

(51) Int. Cl. G03G 15/00

(52) U.S. Cl. CPC G03G 15/6567; G03G 15/6523

(57) ABSTRACT

A processing device includes: a conveyance path part in which a recording medium is conveyed; a cutting part capable of cutting processing of the recording medium conveyed in the conveyance path part; and an orientation changing part that changes an orientation of the recording medium in the conveyance path part, by coming into contact with the recording medium when cutting processing is performed on the recording medium by the cutting part.

### CROSS REFERENCES TO RELATED APPLICATIONS

The present invention claims priority under 35 U.S.C. § 119 to Japanese Application, 2021-151201, filed on Jun. 16, 2021, the entire contents of which being incorporated herein by reference.

### TECHNOLOGICAL FIELD

The present invention relates to a processing device and an image forming system.

### DESCRIPTION OF THE RELATED ART

Conventionally, a processing device for performing cutting processing on a recording medium to be used in an image forming apparatus or the like is known.

In the processing device, a recording medium is cut in a conveyance direction or a direction orthogonal to the conveyance direction, and waste of cutting (hereinafter, cutting waste) is dropped.

In such a processing device, in a case of a configuration of performing cutting processing on various types of recording media such as a recording medium having a short conveyance length such as a business card, an interval between a plurality of conveyance rollers in the processing device is determined according to a recording medium having the minimum size. Therefore, a cutting part is arranged so as to fall within the interval.

In this case, since a drop path for the cutting waste is narrowed, there is a problem of being unable to secure the drop path for the cutting waste depending on the type of the recording medium.

Conventionally, for example, JP 2015-47657 A discloses a configuration for solving the above problem by performing cutting processing in a state where a recording medium is nipped and held by a conveyance roller, then turning the conveyance roller nipping to hold the cutting waste toward a drop path side and rotating the conveyance roller to drop the cutting waste.

Further, by performing the cutting processing a plurality of times, it is possible to perform the cutting processing even on a recording medium having a relatively long conveyance length.

Meanwhile, in a case of performing cutting processing a plurality of times in the processing device, the cutting processing can be performed even on a recording medium having a relatively long conveyance length, but productivity may be reduced since the cutting processing is performed a plurality of times. Furthermore, in a case of performing cutting processing a plurality of times, it is possible to perform the cutting processing while sequentially conveying a front end part of the recording medium. However, for a rear end part, there is a case where the cutting processing is completed after the cutting processing is performed once. That is, it may be not possible to perform the cutting processing a plurality of times on the rear end part of the recording medium. Further, by performing switchback, it is possible to perform the cutting processing a plurality of times also on the rear end part of the recording medium, but the productivity is further lowered.

For these reasons, it is desirable to configure the processing device to be compatible with various types of recording media while improving productivity, by increasing an allowable cutting amount in one time of cutting processing as much as possible.

Note that, in the configuration described in JP 2015-47657 A, control of turning the conveyance roller to drop cutting waste is performed for every one time of cutting processing, which accordingly increases a cutting processing time for one recording medium, and conveyance accuracy may be affected due to control of a turning position of the conveyance roller. That is, the configuration described in JP 2015-47657 A has a certain limit as a configuration for increasing the allowable cutting amount, from the viewpoint of improvement in productivity and conveyance accuracy.

### SUMMARY

An object of the present invention is to provide a processing device and an image forming system capable of increasing an allowable cutting amount in one time of cutting processing.

To achieve the abovementioned object, according to an aspect of the present invention, a processing device reflecting one aspect of the present invention comprises: a conveyance path part in which a recording medium is conveyed; a cutting part capable of cutting processing of the recording medium conveyed in the conveyance path part; and an orientation changing part that changes an orientation of the recording medium in the conveyance path part, by coming into contact with the recording medium when cutting processing is performed on the recording medium by the cutting part.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view schematically illustrating an overall configuration of an image forming system including a processing device according to an embodiment of the present invention.

FIG. 2 is a diagram illustrating a main part of a control system of an image forming apparatus.

FIG. 3 is a view illustrating a configuration of the processing device.

FIG. 4A is a view illustrating the processing device when cutting processing is performed on a front end part of a sheet.

FIG. 4B is a view illustrating the processing device when cutting processing is performed on a front end part of a sheet.

FIG. 5A is a view illustrating the processing device when cutting processing is performed on a rear end part of a sheet.

FIG. 5B is a view illustrating the processing device when cutting processing is performed on a rear end part of a sheet.

FIG. 6 is a view for explaining cutting processing of a processing device not including an orientation changing part.

FIG. 7 is a view for explaining cutting processing of a processing device according to a modification.

FIG. 8A is a view illustrating the processing device according to the modification.

FIG. 8B is a view illustrating the processing device according to the modification.

FIG. 9 is a view illustrating the processing device according to the modification.

### DETAILED DESCRIPTION OF EMBODIMENTS

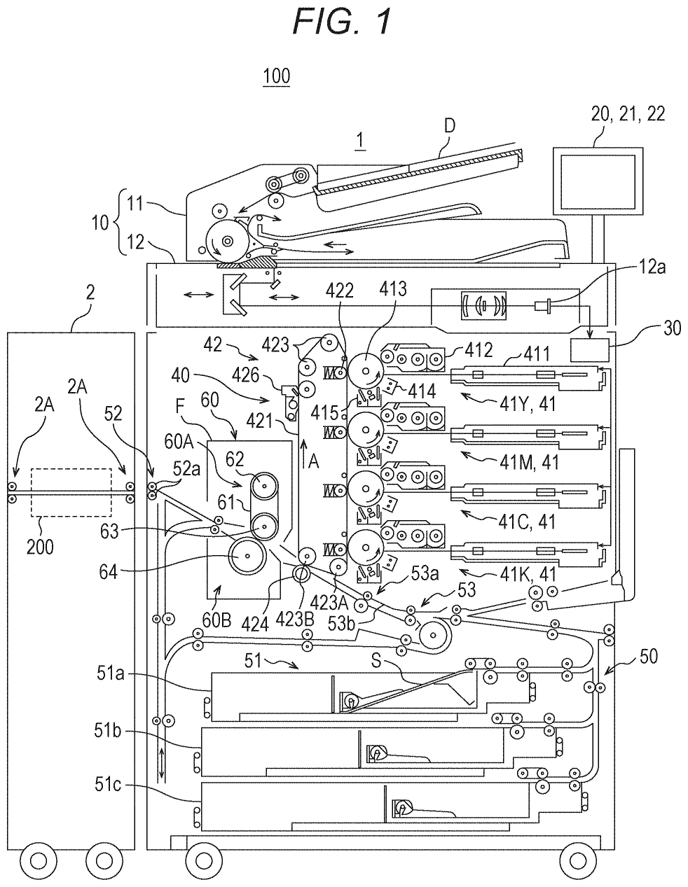

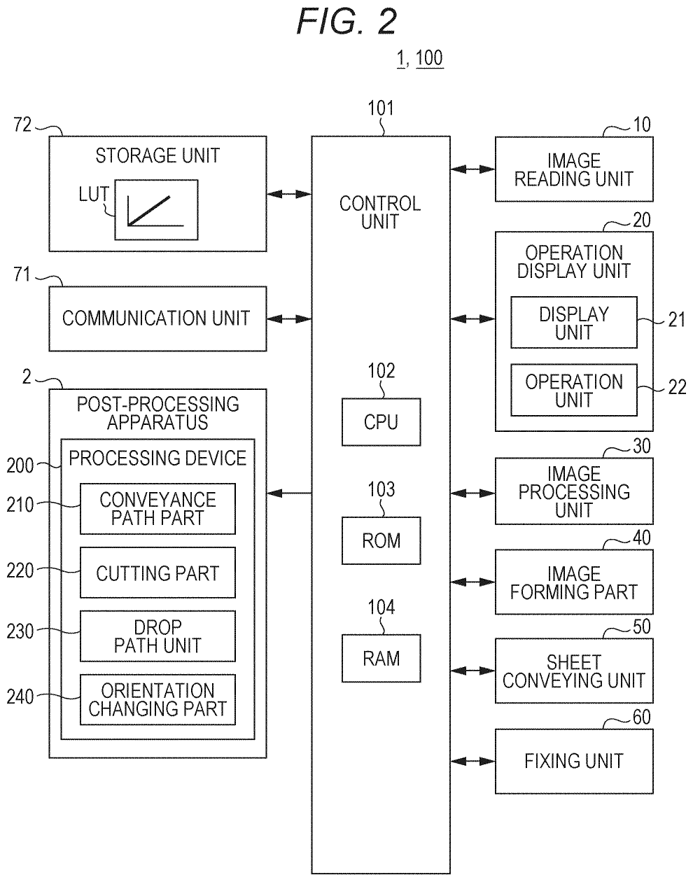

Hereinafter, one or more embodiments of the present invention will be described with reference to the drawings. However, the scope of the invention is not limited to the disclosed embodiments. FIG. 1 is a view schematically illustrating an overall configuration of an image forming system 100 including a processing device 200 according to an embodiment of the present invention. FIG. 2 is a view illustrating a main part of a control system of an image forming apparatus 1.

As illustrated in FIG. 1, the image forming system 100 is configured by connecting the image forming apparatus 1 and a post-processing apparatus 2 from an upstream side along a conveyance direction of a sheet S as an example of a recording medium.

The image forming apparatus 1 is an intermediate-transfer color image forming apparatus using an electrophotographic process technology. That is, the image forming apparatus 1 primarily transfers respective color toner images of yellow (Y), magenta (M), cyan (C), and black (K) formed on photosensitive drums 413 to an intermediate transfer belt 421, superimposes the four color toner images on the intermediate transfer belt 421, and then secondary transfers the toner images onto the sheet S fed from sheet feeding tray units 51a to 51c, to form an image.

Further, to the image forming apparatus 1, a tandem method is employed in which the photosensitive drums 413 corresponding to the four colors of YMCK are arranged in series in a traveling direction of the intermediate transfer belt 421, and toner images of the respective colors are sequentially transferred to the intermediate transfer belt 421 in a single procedure.

As illustrated in FIG. 2, the image forming apparatus 1 includes an image reading unit 10, an operation display unit 20, an image processing unit 30, an image forming part 40, a sheet conveying unit 50, a fixing unit 60, and a control unit 101.

The control unit 101 includes a central processing unit (CPU) 102, a read only memory (ROM) 103, a random access memory (RAM) 104, and the like. The CPU 102 reads a program according to processing contents from the ROM 103, develops the program in the RAM 104, and cooperates with the developed program to centrally control an operation of each block and the like of the image forming apparatus 1. At this time, various data stored in a storage unit 72 are referred to. The storage unit 72 is formed by, for example, a non-volatile semiconductor memory (so-called flash memory) or a hard disk drive.

The control unit 101 exchanges various data with an external device (for example, a personal computer) connected to a communication network such as a local area network (LAN) or a wide area network (WAN), via a communication unit 71. For example, the control unit 101 receives image data (input image data) transmitted from the external device and forms an image on the sheet S on the basis of the image data. The communication unit 71 is formed by, for example, a communication control card such as a LAN card.

As illustrated in FIG. 1, the image reading unit 10 includes an automatic document feeding device 11 called an auto document feeder (ADF), a document image scanning device 12 (scanner), and the like.

The automatic document feeding device 11 conveys a document D placed on a document tray by a conveyance system and sends the document D to the document image scanning device 12. The automatic document feeding device 11 enables continuous reading of images (including both sides) at once of a large number of the documents D placed on the document tray.

The document image scanning device 12 optically scans a document conveyed onto a contact glass from the automatic document feeding device 11 or a document placed on the contact glass and forms an image of reflected light from the document onto a light receiving surface of a charge coupled device (CCD) sensor 12a, to read the document image. The image reading unit 10 generates input image data on the basis of a reading result of the document image scanning device 12. The image processing unit 30 applies predetermined image processing to the input image data.

As illustrated in FIG. 2, the operation display unit 20 is formed by, for example, a liquid crystal display (LCD) with a touch panel, and functions as a display unit 21 and an operation unit 22. The display unit 21 displays various operation screens, a state of an image, an operation status of each function, and the like in accordance with a display control signal inputted from the control unit 101. The operation unit 22 includes various operation keys such as a ten key and a start key, receives various input operations by a user, and outputs an operation signal to the control unit 101.

The image processing unit 30 includes a circuit or the like that performs digital image processing according to initial setting or user setting. For example, the image processing unit 30 performs gradation correction on the basis of gradation correction data (gradation correction table) under the control of the control unit 101. Further, the image processing unit 30 performs various correction processes such as color correction and shading correction in addition to the gradation correction, compression processing, and the like. On the basis of the image data subjected to these processes, the image forming part 40 is controlled.

As illustrated in FIG. 1, the image forming part 40 forms an image on the sheet S on the basis of setting of a print job. The image forming part 40 includes: image forming units 41Y, 41M, 41C, and 41K that form an image with respective color toners of a Y component, an M component, a C component, and a K component on the basis of input image data; an intermediate transfer unit 42; and the like.

The image forming units 41Y, 41M, 41C, and 41K for the Y component, the M component, the C component, and the K component have a similar configuration. For convenience of illustration and description, common constituents are denoted by the same reference numerals, and the individual constituents are indicated by adding Y, M, C or K to the reference numerals when being distinguished. In FIG. 1, reference numerals are given exclusively to the constituents of the image forming unit 41Y for the Y component, and reference numerals of the constituents of other image forming units 41M, 41C, and 41K are omitted.

The image forming unit 41 includes an exposure device 411, a developing device 412, the photosensitive drum 413, a charging device 414, a drum cleaning device 415, and the like.

The photosensitive drum 413 is made of, for example, an organic photoreceptor in which a photosensitive layer made of a resin containing an organic photoconductor is formed on an outer peripheral surface of a drum-shaped metal base.

The control unit 101 controls a drive current supplied to a drive motor (not shown) that rotates the photosensitive drum 413, to rotate the photosensitive drum 413 at a constant peripheral speed.

The charging device 414 is, for example, an electrostatic charger, and generates corona discharge to uniformly charge a surface of the photoconductive photosensitive drum 413 to a negative polarity.

The exposure device 411 is formed by, for example, a semiconductor laser, and irradiates the photosensitive drum 413 with a laser beam corresponding to an image of each color component. As a result, an electrostatic latent image of each color component is formed on an image region irradiated with the laser light on the surface of the photosensitive drum 413, due to a potential difference with a background region.

The developing device 412 is a two-component reverse rotation developing device and visualizes the electrostatic latent image to form a toner image by causing developer of each color component to adhere to the surface of the photosensitive drum 413.

The developing device 412 is applied with, for example, a DC developing bias having the same polarity as a charging polarity of the charging device 414, or a developing bias in which a DC voltage having the same polarity as a charging polarity of the charging device 414 is superimposed on an AC voltage. As a result, reverse development is performed in which toner is made adhere to the electrostatic latent image formed by the exposure device 411.

The drum cleaning device 415 is in contact with a surface of the photosensitive drum 413, has a flat drum cleaning blade made of an elastic body, and the like, and removes toner remaining on the surface of the photosensitive drum 413 without being transferred to the intermediate transfer belt 421.

The intermediate transfer unit 42 includes the intermediate transfer belt 421, a primary transfer roller 422, a plurality of support rollers 423, a secondary transfer roller 424, a belt cleaning device 426, and the like.

The intermediate transfer belt 421 is formed by an endless belt and is stretched in a loop around the plurality of support rollers 423. At least one of the plurality of support rollers 423 is formed by a drive roller, and others are formed by a driven roller. For example, it is desirable that a roller 423A disposed downstream of the primary transfer roller 422 for the K component in a belt traveling direction is the drive roller. This makes it easy to keep a constant traveling speed of the belt in a primary transfer unit. As the drive roller 423A rotates, the intermediate transfer belt 421 travels at a constant speed in an arrow A direction.

The intermediate transfer belt 421 is a belt having conductivity and elasticity and has a high resistance layer on a surface thereof. The intermediate transfer belt 421 is rotationally driven by a control signal from the control unit 101.

The primary transfer roller 422 is disposed on an inner peripheral surface side of the intermediate transfer belt 421, so as to face the photosensitive drum 413 of each color component. By pressure contact of the primary transfer roller 422 and the photosensitive drum 413 with the intermediate transfer belt 421 interposed in between, the primary transfer nip for transfer of a toner image from the photosensitive drum 413 to the intermediate transfer belt 421 is formed.

The secondary transfer roller 424 is disposed on an outer peripheral surface side of the intermediate transfer belt 421, so as to face a backup roller 423B disposed on downstream of the drive roller 423A in the belt traveling direction. By pressure contact of the secondary transfer roller 424 and the backup roller 423B with the intermediate transfer belt 421 interposed in between, a secondary transfer nip for transfer of a toner image from the intermediate transfer belt 421 to the sheet S is formed.

When the intermediate transfer belt 421 passes through the primary transfer nip, the toner image on the photosensitive drum 413 is sequentially superimposed and primarily transferred on the intermediate transfer belt 421. Specifically, by applying a primary transfer bias to the primary transfer roller 422 and supplying a charge of a polarity opposite to that of the toner to a back surface side of the intermediate transfer belt 421, that is, a side in contact with the primary transfer roller 422, the toner image is electrostatically transferred to the intermediate transfer belt 421.

Thereafter, when the sheet S passes through the secondary transfer nip, the toner image on the intermediate transfer belt 421 is secondarily transferred to the sheet S. Specifically, by applying a secondary transfer bias to the secondary transfer roller 424 and applying a charge having a polarity opposite to that of toner to the back surface side of the sheet S, that is, a side in contact with the secondary transfer roller 424, the toner image is electrostatically transferred to the sheet S. The sheet S transferred with the toner image is conveyed toward the fixing unit 60.

The belt cleaning device 426 removes transfer residual toner remaining on a surface of the intermediate transfer belt 421 after the secondary transfer.

The fixing unit 60 includes: an upper fixing unit 60A having a fixing-surface-side member disposed on a fixing surface side of the sheet S, that is, on a surface side formed with the toner image; a lower fixing unit 60B having a back-surface-side support member disposed on a back surface side of the sheet S, that is, on a side opposite to the fixing surface side; a heating source; and the like. By pressure contact of the back-surface-side support member on the fixing-surface-side member, a fixing nip to hold and convey the sheet S is formed.

The fixing unit 60 fixes the toner image onto the sheet S by heating and pressurizing, with the fixing nip, the sheet S on which the toner image has been secondarily transferred and that has been conveyed. The fixing unit 60 is disposed as a unit in a fixing device F.

The upper fixing unit 60A includes an endless fixing belt 61, a heating roller 62, and a fixing roller 63, which are fixing-surface-side members. The fixing belt 61 is stretched around the heating roller 62 and the fixing roller 63.

The lower fixing unit 60B includes a pressure roller 64 which is a back-surface-side support member. The pressure roller 64 forms a fixing nip that nips to hold and conveys the sheet S between with the fixing belt 61.

The sheet conveying unit 50 includes a sheet feeding unit 51, a sheet discharging unit 52, a conveyance path part 53, and the like. In the three sheet feeding tray units 51a to 51c forming the sheet feeding unit 51, the sheets S (standard sheets, special sheets) identified on the basis of a basis weight, a size, and the like are accommodated for each preset type.

The conveyance path part 53 includes: a plurality of conveyance roller pairs such as a registration roller pair 53a; a normal conveyance path 53b that allows the sheet S to pass through the image forming part 40 and the fixing unit 60 and to be discharged to outside the image forming apparatus 1; and the like.

The sheets S accommodated in the sheet feeding tray units 51a to 51c are fed one by one from the top and conveyed to the image forming part 40 by the conveyance path part 53. The toner image of the intermediate transfer belt 421 is secondarily transferred collectively on one side of the sheet S in the image forming part 40, and a fixing process is performed in the fixing unit 60. The sheet S formed with an image is discharged outside the apparatus by the sheet discharging unit 52 provided with a sheet discharge roller 52a.

The post-processing apparatus 2 is an apparatus that carries in the sheet S discharged from the image forming apparatus 1 and performs predetermined post-processing on the sheet S on which an image is formed and includes the processing device 200. The post-processing apparatus 2 includes a conveyance unit 2A capable of conveying the sheet S. The post-processing apparatus 2 conveys the sheet S carried in from the image forming apparatus 1 to a portion of the processing device 200, for example, under control of the control unit 101 of the image forming apparatus 1, performs processing, and then discharges the sheet S to outside the apparatus. The discharged sheet S is placed on, for example, a sheet discharging tray (not illustrated), or is carried into a post-processing apparatus when another post-processing apparatus is connected to the image forming system 100. Note that the post-processing apparatus 2 (the processing device 200) may include a control unit including a CPU, a ROM, a RAM, and the like, and the control unit may perform control related to conveyance and processing of the sheet S.

The processing device 200 is a device for performing cutting processing on the sheet S (a recording medium), and includes a conveyance path part 210, a cutting part 220, a drop path unit 230, and an orientation changing part 240.

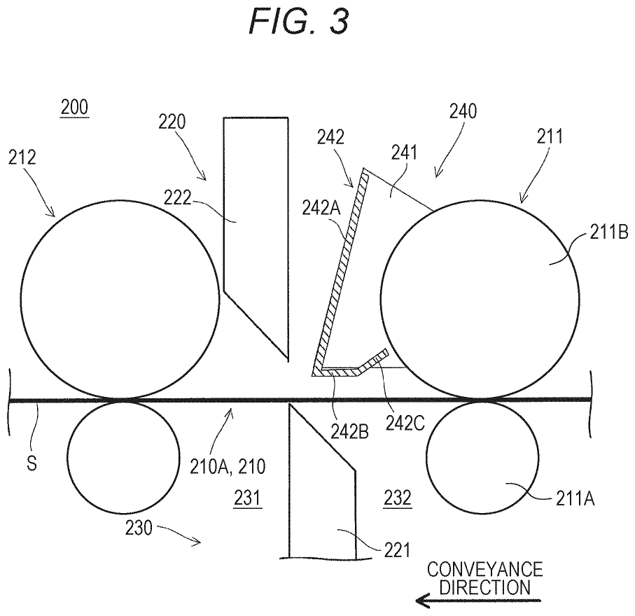

As illustrated in FIG. 3, the conveyance path part 210 is a part constituting a conveyance path 210A that conveys the sheet S and includes two conveyance rollers 211 and 212. The conveyance path 210A is a path between the two conveyance rollers 211 and 212.

The two conveyance rollers 211 and 212 are roller pairs that nip to hold the sheet S conveyed in the conveyance path 210A. The conveyance roller 211 is a roller pair located on the upstream side in a conveyance direction of the sheet S in the conveyance path 210A. The conveyance roller 212 is a roller pair located on a downstream side in the conveyance direction of the sheet S in the conveyance path 210A.

The cutting part 220 is a part that performs cutting processing on the sheet S conveyed in the conveyance path part 210 and is disposed between the two conveyance rollers 211 and 212 in the conveyance path part 210. The cutting part 220 includes a first cutting part 221 and a second cutting part 222 disposed so as to sandwich the conveyance path 210A.

The first cutting part 221 is a fixed blade fixed below the conveyance path 210A and is disposed such that a blade capable of cutting processing of the sheet S faces the conveyance path 210A side (an upper side).

The second cutting part 222 is a movable blade disposed above the conveyance path 210A and is disposed such that a blade capable of cutting processing of the sheet S faces the conveyance path 210A side (a lower side). The second cutting part 222 is disposed adjacent to the first cutting part 221 on a downstream side of the first cutting part 221 in the conveyance direction.

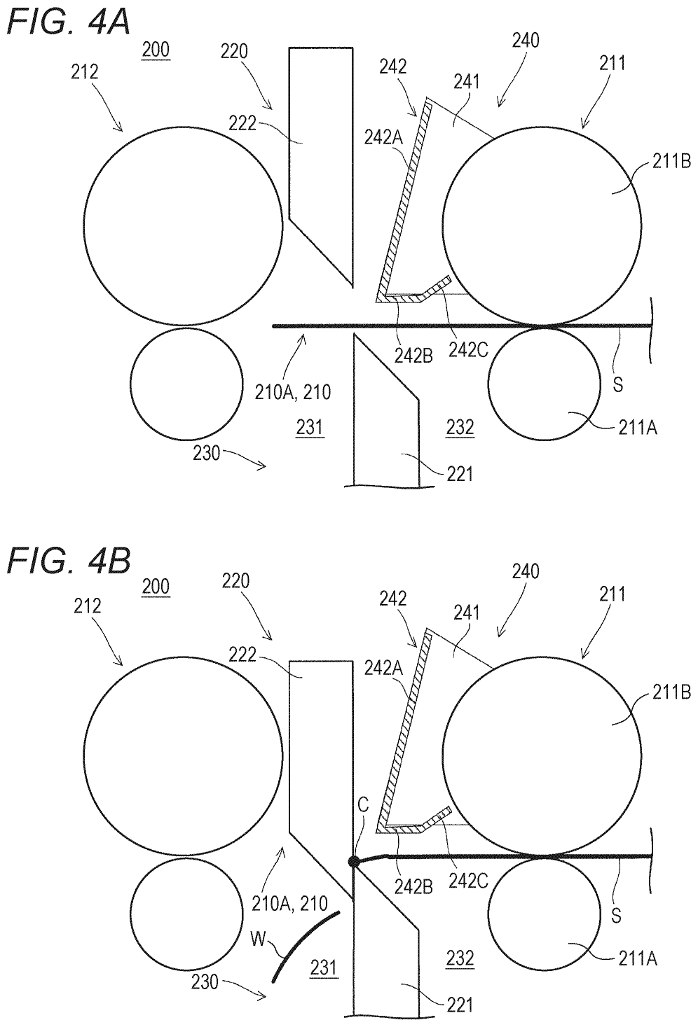

The second cutting part 222 is provided to be movable in a direction (a vertical direction) facing the conveyance path 210A and is movable between a non-cutting position (see FIGS. 3, FIG. 4A, and the like) retracted from the conveyance path 210A and a cutting position (see FIG. 4B) for cutting the sheet S on the conveyance path 210A.

The cutting position is a position where the blade portion of the second cutting part 222 is located below the blade portion of the first cutting part 221. The blade portion of the second cutting part 222 is located at a position adjacent to the blade portion of the first cutting part 221 in the conveyance direction of the sheet S. When the second cutting part 222 moves from the non-cutting position toward the cutting position, cutting processing is performed on the sheet S in the conveyance path 210A at a cutting point C (see FIG. 4B) where the blade portion of the first cutting part 221 and the blade portion of the second cutting part 222 are at the same position in the vertical direction.

The drop path unit 230 is a path in which cutting waste W, which is waste of the sheet S cut by the cutting part 220, falls, and includes a first path 231 and a second path 232. Below the first path 231 and the second path 232, a waste container (not illustrated) is provided, and cutting waste dropped from the drop path unit 230 is stored in the waste container.

The first path 231 is a space adjacent to the first cutting part 221 below the second cutting part 222 and on a downstream side in the conveyance direction. For example, as illustrated in FIG. 4A and FIG. 4B, the first path 231 is a path in which the cutting waste W corresponding to a front end part of the sheet S falls when cutting processing is performed on the front end part of the sheet S by the cutting part 220. In the first path 231, the cutting waste W is pushed to be dropped by the second cutting part 222 moving to the cutting position.

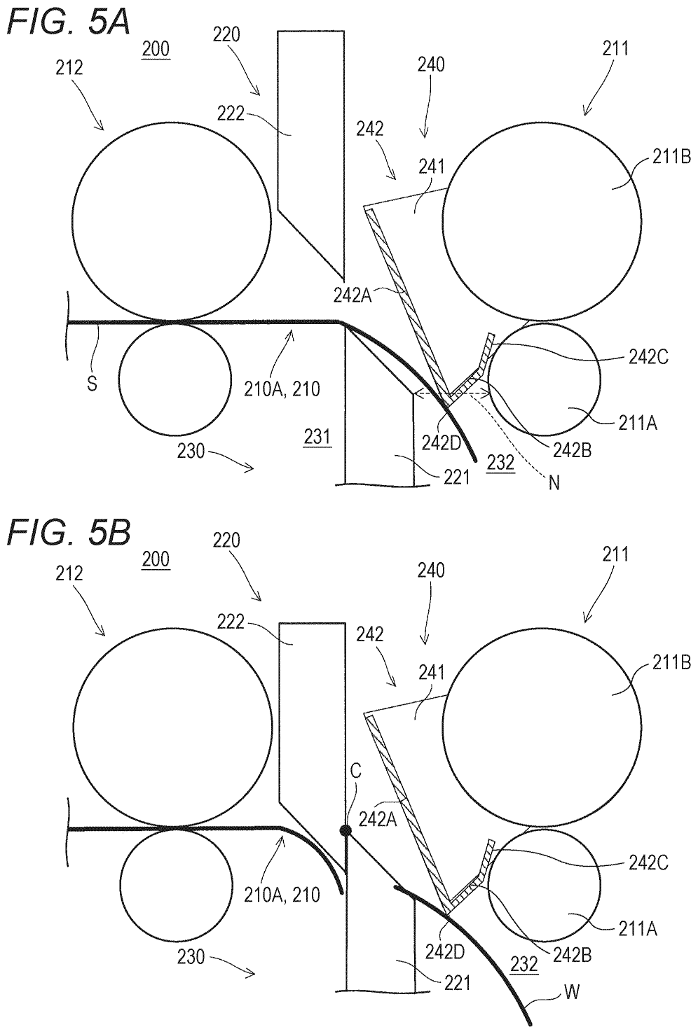

The second path 232 is a space between the first cutting part 221 and the conveyance roller 211 and is a space adjacent to the first cutting part 221 on the upstream side in the conveyance direction. For example, as illustrated in FIG. 5A and FIG. 5B, the second path 232 is a path in which the cutting waste W corresponding to the rear end part of the sheet S falls when cutting processing is performed on the rear end part of the sheet S by the cutting part 220. The second path 232 corresponds to a “space into which cutting waste moves after cutting processing” of the present invention.

An entrance of the second path 232 is a portion where the first cutting part 221 and the conveyance roller 211 face each other. The first cutting part 221 is inclined so as to approach the conveyance roller 211 (a lower roller 211A) as going downward in the entrance part. Therefore, in the inclined portion of the first cutting part 221, a position (a range of N indicated by a broken line arrow) corresponding to a portion closest to the conveyance roller 211 is a narrowest position in the entrance part.

The entrance of the second path 232 may have any shape.

The orientation changing part 240 is a part that changes an orientation of the sheet S in the conveyance path part 210 by coming into contact with the sheet S when the sheet S is subjected to the cutting processing by the cutting part 220. The orientation changing part 240 is provided on the conveyance roller 211 of the conveyance path part 210. The orientation changing part 240 includes a turning unit 241 and a pushing unit 242.

The turning unit 241 is provided on a rotation shaft of an upper roller 211B of the conveyance roller 211 and is turnable with respect to the rotation shaft. For example, a pair of the turning units 241 are provided at both ends of the rotation shaft and are disposed so as to protrude from the rotation shaft toward the downstream side in the conveyance direction.

The pushing unit 242 extends in an axial direction of the conveyance roller 211 so as to correspond to the entire conveyance area of the sheet S and connects the pair of the turning units 241. The pushing unit 242 pushes the sheet S that is present in the conveyance path part 210, by the turning unit 241 turning.

Specifically, when the turning unit 241 turns, the pushing unit 242 moves between a retraction position (see FIG. 4A and the like) retracted from the conveyance path 210A and a pushing position (see FIG. 5A and the like) for pushing the sheet S in the conveyance path 210A.

The retraction position is, for example, a position retracted upward from the sheet S in an ideal state of being nipped and held between the two conveyance rollers 211 and 212. The pushing position is a position where the pushing unit 242 pushes down the sheet S in the ideal state. The sheet S in the ideal state is a sheet S in a state of being parallel to the conveyance direction.

The pushing unit 242 includes a first portion 242A, a second portion 242B, and a third portion 242C.

As illustrated in FIG. 4A, the first portion 242A is a portion extending substantially downward from an upper end part of the turning unit 241 when the pushing unit 242 is at the retraction position.

The second portion 242B is a portion extending toward the upstream side in the conveyance direction, from a lower end of the first portion 242A when the pushing unit 242 is at the retraction position. The second portion 242B is substantially parallel to the sheet S in the ideal state when the pushing unit 242 is at the retraction position.

The third portion 242C is a portion extending so as to be located upward as going toward the upstream side in the conveyance direction, from an upstream end of the second portion 242B when the pushing unit 242 is at the retraction position. In other words, when the pushing unit 242 is at the retraction position, the third portion 242C is inclined so as to approach the conveyance path 210A as going from upstream to downstream in the conveyance direction.

With the configuration described above, when the pushing unit 242 is at the retraction position, the second portion 242B and the third portion 242C function as guide parts for the sheet S conveyed through the conveyance path part 210.

Further, when the turning unit 241 turns from the retraction position to the pushing position, as illustrated in FIG. 5A, a connection portion 242D between the first portion 242A and the second portion 242B of the pushing unit 242 faces downward and pushes the sheet S on the conveyance path 210A downward.

As a result, the orientation of the sheet S is changed such that an end of the sheet S in the conveyance path 210A faces obliquely downward. That is, the orientation changing part 240 pushes the sheet S such that a portion of the sheet S that becomes the cutting waste W after the cutting processing is inclined with respect to the conveyance direction.

By changing the orientation in this manner, it is possible to make it easy for cutting waste to enter a lower space between the conveyance roller 211 and the cutting part 220. Therefore, an allowable cutting amount of the sheet S that can be subjected to the cutting processing can be increased as compared with the sheet S that is not pushed by the pushing unit 242.

Further, as illustrated in FIG. 5B, the turning unit 241 turns up to a position where the connection portion 242D in the pushing unit 242 is located below the cutting point C of the cutting part 220. That is, the pushing unit 242 pushes the sheet S to a position protruding farther than the cutting point C in the cutting part 220 with respect to the conveyance path 210A.

As a result, the cutting waste can be easily pushed into the drop path unit 230.

Further, in a case of the pushing position, the connection portion 242D in the pushing unit 242 turns up to a position equal to or lower than the narrowest portion of the second path 232 in the drop path unit 230.

As a result, it is possible to suppress the cutting waste W from being caught at the entrance part of the second path 232, so that the cutting waste W can be reliably dropped in the drop path unit 230.

In addition, the pushing unit 242 is disposed such that the connection portion 242D pulls the sheet S to a side opposite to the conveyance direction when the turning unit 241 turns to be located at the pushing position. That is, the pushing unit 242 pushes the sheet S so as to pull the sheet S toward a side away from the cutting part 220 in the conveyance direction.

As a result, an appropriate tensile force acts on the sheet S to be subjected to the cutting processing, so that the cutting processing in the cutting part 220 can be stabilized.

Next, an operation of the processing device 200 according to the present embodiment will be described. In the post-processing apparatus 2, in an initial state, as illustrated in FIG. 3, the pushing unit 242 is located at the retraction position in the orientation changing part 240, and the second cutting part 222 is located at the non-cutting position.

First, in the image forming apparatus 1, an image is formed on the sheet S to be subjected to the cutting processing, and the sheet S is carried into the post-processing apparatus 2. Conveyance of the conveyed sheet S in the post-processing apparatus 2 is stopped such that a portion to be subjected to the cutting processing is located at a position corresponding to the cutting part 220 in the processing device 200.

When a portion corresponding a front end part of the sheet S is to be cut, the conveyance of the sheet S is stopped for each portion to be subjected to the cutting processing as illustrated in FIG. 4A, and the second cutting part 222 is moved to the cutting position to perform the cutting processing every time as illustrated in FIG. 4B. At that time, the pushing unit 242 remains at the retraction position. The cutting waste in this case is pushed out by the second cutting part 222 and falls through the first path 231 of the drop path unit 230.

Furthermore, when a portion corresponding to a rear end part of the sheet S is cut, the conveyance of the sheet S is stopped after a portion of the rear end part of the sheet S to be subjected to the cutting processing reaches the position of the cutting part 220. Before the cutting processing by the cutting part 220, as illustrated in FIG. 5A, the pushing unit 242 moves from the retraction position to the pushing position.

As a result, the rear end part of the sheet S is curved by being pushed by the pushing unit 242, and enters a space below the conveyance path 210A. Thereafter, as illustrated in FIG. 5B, the second cutting part 222 of the cutting part 220 moves to the cutting position, and the rear end part of the sheet S is subjected to the cutting processing.

In this case, since the cutting waste W is pushed into the second path 232 of the drop path unit 230 by the pushing unit 242, the cutting waste W falls as it is through the second path 232.

After the cutting processing by the cutting part 220, the second cutting part 222 moves to the non-cutting position, the pushing unit 242 moves to the retraction position, the conveyance of the sheet S is restarted, and the sheet S on which the cutting processing has been completed is discharged from the post-processing apparatus 2.

According to the present embodiment configured as described above, when the cutting processing is performed on the rear end part of the sheet S, the orientation of the sheet S is changed by pushing (contacting) the sheet S.

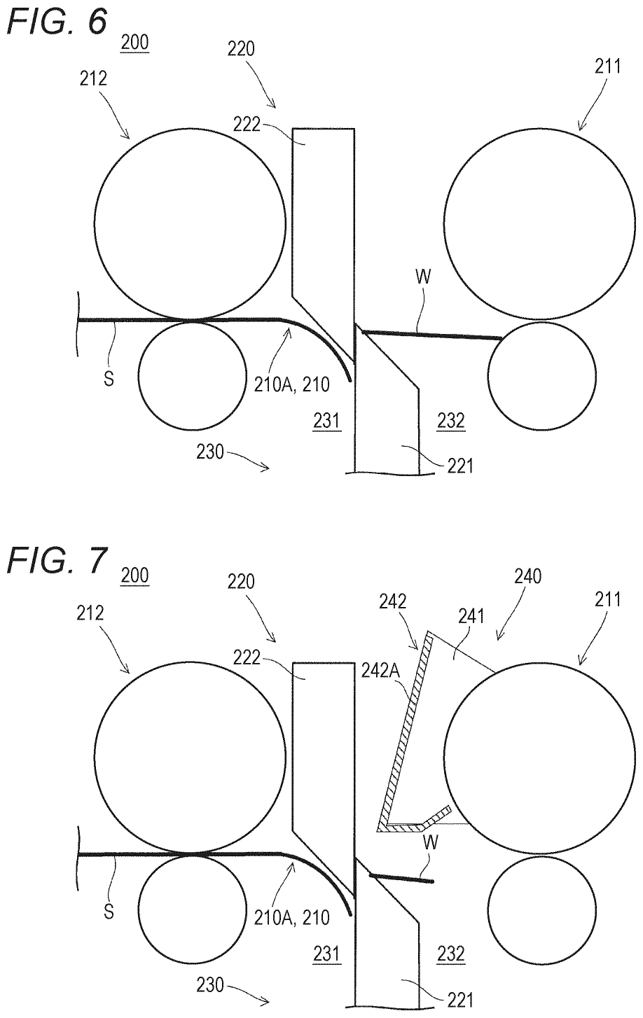

For example, assuming that it is necessary to cut a range to be longer than the allowable length in the conveyance direction of the drop path unit 230 at the rear end part of the sheet S. In this case, if the orientation of the sheet S is not changed, as illustrated in FIG. 6, cutting is performed without changing the orientation of the sheet S at the time of cutting processing from a state of being substantially parallel to the conveyance path 210A. Therefore, there is a possibility that the cutting waste W does not fall in the drop path unit 230 but is caught by the entrance of the drop path unit 230 and remains.

Whereas, in the present embodiment, as illustrated in FIG. 5A, since the orientation of the sheet S is changed when cutting processing is performed on the rear end part of the sheet S, a portion to be the cutting waste W can be inclined with respect to the conveyance path 210A. As a result, even when the allowable length of the drop path unit 230 is relatively narrow, cutting waste easily enters the drop path unit 230, and thus it is possible to inhibit the cutting waste from remaining at the entrance of the drop path unit 230.

That is, in the present embodiment, the allowable cutting amount in one time of cutting processing can be increased.

In addition, since the allowable cutting amount in one time of cutting processing can be increased, there is no need to perform cutting processing on the rear end part of the sheet S a plurality of times by, for example, performing switch-back or the like, and thus productivity can be improved.

Further, since the pushing unit 242 pushes the sheet S to be located below the cutting point C in the cutting part 220, it is possible to easily push the cutting waste W into the drop path unit 230.

Further, in a case of the pushing position, since the connection portion 242D in the pushing unit 242 turns up to a position equal to or lower than the narrowest portion of the second path 232 in the drop path unit 230, it is possible to inhibit the cutting waste W from being caught in the second path 232. As a result, the cutting waste W can be reliably dropped in the drop path unit 230.

Meanwhile, when the sheet S at the position corresponding to the cutting part 220 is in a deflected state, there is a possibility that the position of cutting processing by the cutting part 220 is shifted. However, in the present embodiment, the pushing unit 242 pushes the sheet S so as to pull the sheet S toward the side away from the cutting part 220.

As a result, an appropriate tensile force acts on the sheet S to be cut, and the sheet S is brought into a stretched state even if the sheet S to be cut is deflected. Therefore, it is possible to inhibit the shift of the position of the cutting processing and to stabilize the cutting processing in the cutting part 220.

Further, since the orientation changing part 240 is provided corresponding to the entire conveyance area of the sheet S, the orientation of the entire width of the sheet S can be changed. As a result, the cutting waste can be reliably pushed into the drop path unit 230. Further, in a configuration in which a part of the sheet S in the width direction is pushed, deflection in the width direction is likely to occur in the sheet S. Whereas, in the present embodiment, since the entire width of the sheet S is pushed, deflection in the width direction does not occur in the sheet S, so that the cutting processing in the cutting part 220 can be stabilized.

In the above-described embodiment, when cutting processing is performed on the rear end part of the sheet S, the orientation changing part 240 is always moved to the pushing position. However, the present invention is not limited thereto, and the orientation changing part 240 may not be always moved to the pushing position. For example, the orientation changing part 240 may be able to adjust a movable amount according to a cutting amount of the sheet S.

By doing in this way, for example, under the control of the control unit 101, the pushing unit 242 is movable when the cutting amount of the sheet S is equal to or more than a predetermined amount, and the pushing unit 242 is not movable when the cutting amount of the sheet S is less than the predetermined amount (see FIG. 7). The predetermined amount can be appropriately set such as, for example, a cutting amount equal to a length of the narrowest portion of the second path 232.

As a result, since the pushing unit 242 is movable exclusively, when necessary, a process of the cutting processing can be shortened when the pushing unit 242 is not movable, and thus productivity can be improved, and power consumption can be reduced.

Furthermore, for example, under the control of the control unit 101, the position of the pushing unit 242 may be adjusted such that the pushing unit 242 approaches the pushing position as the cutting amount of the sheet S increases.

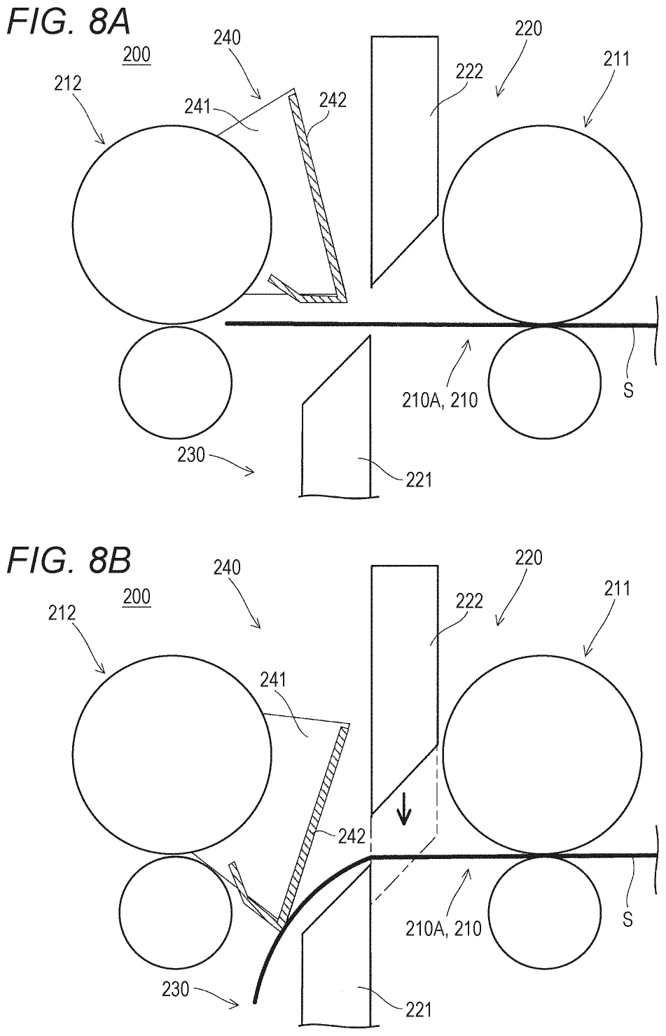

Further, in the above-described embodiment, when cutting processing is performed on the rear end part of the sheet S, the orientation changing part 240 is arranged at a position where the rear end part of the sheet S can be pushed, but the present invention is not limited thereto. For example, as illustrated in FIG. 8A and FIG. 8B, when cutting processing is performed on the front end part of the sheet S, the orientation changing part 240 may be arranged at a position where the front end part of the sheet S can be pushed.

In this case, the orientation changing part 240 is provided at a position where the front end part of the sheet S can be pushed.

Specifically, the turning unit 241 is provided on a rotation shaft of an upper roller of the conveyance roller 212 located on the downstream side in the conveyance direction and protrudes from the rotation shaft toward the upstream side in the conveyance direction.

In this configuration, a positional relationship between the first cutting part 221 and the second cutting part 222 in the conveyance direction is opposite to that in the above-described embodiment. That is, the second cutting part 222 is adjacent to the first cutting part 221 on the upstream side in the conveyance direction.

The pushing unit 242 is provided in the turning unit 241 and moves between the retraction position (a position in FIG. 8A) and the pushing position (a position in FIG. 8B) by turning of the turning unit 241 as in the above-described embodiment.

By doing in this way, it is possible to increase an allowable cutting amount per one time when cutting processing is performed on the front end part of the sheet S.

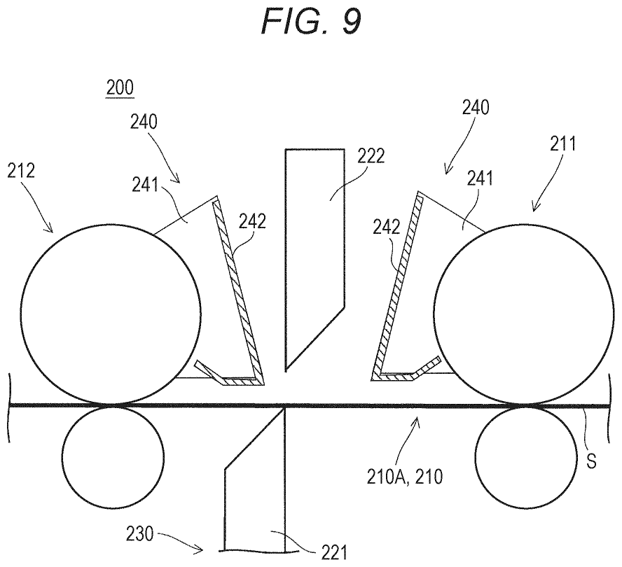

Further, as illustrated in FIG. 9, the orientation changing part 240 may be arranged at positions where both the front end part and the rear end part of the sheet S can be pushed. The orientation changing part 240 in this configuration has the same configuration as the orientation changing part 240 illustrated in FIGS. 3, FIG. 8A, and the like.

By doing in this way, since an allowable cutting amount at each of the front end part and the rear end part of the sheet S can be increased, productivity in cutting processing of each of the front end part and the rear end part can be improved. In addition, since the configuration corresponds to cutting processing on both the front end part and the rear end part of the sheet S, it is not necessary to change the processing device in accordance with the portion to be subjected to the cutting processing, and convenience can be improved.

Further, in the above-described embodiment, the orientation changing part 240 can push the sheet S to be located below the narrowest position of the entrance part for the cutting waste W in the drop path unit 230, but the present invention is not limited thereto, and the sheet S may not be able to be pushed to the position. However, from the viewpoint of reliably pushing the sheet S into the drop path unit 230, the sheet S can be preferably pushed to at least the narrowest position of the entrance part.

Further, in the above-described embodiment, the orientation changing part 240 pushes the sheet S so as to pull the sheet S toward the side away from the cutting part 220, but the present invention is not limited thereto, and the sheet S may not be pushed so as to be pulled.

In the above-described embodiment, the pushing unit 242 is provided corresponding to the entire conveyance area of the sheet S. However, the present invention is not limited thereto, and the pushing unit may not be provided corresponding to the entire conveyance region.

Furthermore, in the above-described embodiment, the orientation changing part 240 pushes the sheet S before the cutting processing by the cutting part 220 is started, but the present invention is not limited thereto. For example, the orientation changing part 240 may push the sheet S simultaneously with the start of the cutting processing.

In the above-described embodiment, the pushing unit 242 has the guide part for the sheet S, but the present invention is not limited thereto, and the guide part may not be provided.

In the above-described embodiment, the processing device 200 is provided in the post-processing apparatus 2, but the present invention is not limited thereto, and the processing device 200 may be included in the image forming apparatus 1.

Although embodiments of the present invention have been described and illustrated in detail, the disclosed embodiments are made for purposes of illustration and example only and not limitation. The scope of the present invention should be interpreted by terms of the appended claims. That is, the present invention can be implemented in various forms without departing from the scope or main features of the present invention.

What is claimed is:

1. A processing device comprising:
a conveyance path part in which a recording medium is conveyed;
a cutting part capable of cutting processing of the recording medium conveyed in the conveyance path part; and
an orientation changing part that changes an orientation of the recording medium in the conveyance path part, by coming into contact with the recording medium when cutting processing is performed on the recording medium by the cutting part.

2. The processing device according to claim 1, wherein
the orientation changing part pushes the recording medium to cause inclination of a portion that becomes cutting waste after cutting processing in the recording medium, with respect to a conveyance direction of the recording medium in the conveyance path part.

3. The processing device according to claim 1, wherein
the cutting part is able to perform cutting processing on the recording medium at a cutting point that is predetermined, and
the orientation changing part pushes the recording medium to a position protruding farther than the cutting point, with respect to a conveyance path in the conveyance path part.

4. The processing device according to claim 1, wherein
the orientation changing part pushes a portion of the recording medium that becomes cutting waste after cutting processing, toward a space into which the cutting waste moves after the cutting processing.

5. The processing device according to claim 4, wherein
the orientation changing part pushes the recording medium up to at least a narrowest position of an entrance part for the cutting waste in the space.

6. The processing device according to claim 1, wherein
the orientation changing part pushes the recording medium to pull the recording medium toward a side away from the cutting part in a conveyance direction of the recording medium.

7. The processing device according to claim 1, wherein
the orientation changing part is provided corresponding to an entire conveyance area of the recording medium in the conveyance path part.

8. The processing device according to claim 1, wherein
the orientation changing part pushes the recording medium whose conveyance has been stopped in the conveyance path part, before cutting processing by the cutting part is started.

9. The processing device according to claim 1, wherein
the orientation changing part is movable between a pushing position where the recording medium is pushed, and a retraction position retracted from the pushing position.

10. The processing device according to claim 1, wherein
the orientation changing part is disposed at a position to allow at least one of a front end part or a rear end part in a conveyance direction of the recording medium to be pushed when cutting processing is performed on the at least one.

11. The processing device according to claim 1, wherein
the orientation changing part is able to adjust a movable amount in accordance with a cutting amount of the recording medium.

12. The processing device according to claim 1, wherein
the orientation changing part includes a guide part for the recording medium in the conveyance path part.

13. An image forming system comprising:
an image forming part that forms an image on a recording medium;
a conveyance path part in which the recording medium on which the image is formed is conveyed;
a cutting part capable of cutting processing of the recording medium conveyed in the conveyance path part; and
an orientation changing part that changes an orientation of the recording medium in the conveyance path part, by coming into contact with the recording medium when cutting processing is performed on the recording medium by the cutting part.
